(19) United States
(12) Patent Application Publication
(10) Pub. No.: US 2004/0216039 A1
(43) Pub. Date: Oct. 28, 2004

(54) Automated method and collaborative process related to legal and regulatory requirements for document creation and document records management

(76) Inventors: Kathleen Lane, Los Altos Hills, CA (US); William Hustale Lane, Los Altos Hills, CA (US)

Correspondence Address: PATRICK REILLY, BOX 7218, SANTA CRUZ, CA, 95061-7218, US

(21) Appl. No.: 10/423,793

(22) Filed: Apr. 25, 2003

(51) Int. Cl. G06F 15/00

(52) U.S. Cl. 715/511

(57) ABSTRACT

A single development platform is provided which can define automated collaborative process methods for electronically generating, storing, and transmitting employment documents within a shared computer network, and granting rights to Users, such as employers, employees, records management staff and identity verification agencies, to collaboratively start, manage, complete, store, index, retrieve and dispose of the documents and related subject matter document images and related records. A single environment executes rules and policies for both the creation and records management of a record, and enforces associated records management rules and policies to automatically execute legal and regulatory rules appropriate for the storage, retrieval and disposition of an electronic file. The present invention more particularly relates to business process management within shared workspace information technology systems used provide real time validation of employee identity and to associate such validation as part of an I-9 or immigration report electronic file.

### TECHNICAL FIELD

This invention is related to automated collaborative business processes for electronically generating and storing documents containing important or legally significant statements, such as an I-9 form, prepared in fulfillment of (1) a governmental law or regulation, or (2) other business, societal or organizational intent or requirement. More particularly, the present invention relates to providing an electronic collaborative workspace wherein two or more participants may combine efforts to prepare, maintain, store, retrieve, dispose, and/or manage in light of legal, regulatory, associational, or organizational rules, standards, intents, processes, or strategies for creating, storing and retrieving documents.

### BACKGROUND OF THE INVENTION

The creation, storage and management of document by means of a computer network is well known in the prior art. The prior art techniques fail, however, to provide methods to optimally and collaboratively define the life cycle of a document from its creation to its disposition. The document life cycle defines rules which generate, validate, process, store, retrieve, dispose and manage documents in a single shared and/or connected workspace that have legal, regulatory, or informational significance.

A business process may include a sequence of steps executed by a set of users or participants where one or more steps may be assigned to one or more specific users. To execute a business process, a participant, such as a person, a commercial entity, a governmental agency, or an association, may be assigned to execute a Step A, while another participant or participants are assigned to a Step B, etc. A workflow system implemented in a distributed technology system, such as the Internet, can use a route, that comprises a pattern or matrix of workflow nodes, to manage and document a business process by mapping the intended or occurring sequence of business process steps to a related sequence of nodes in the workflow route and assigning to one or more nodes a participant(s) authorized to execute a business process step. Prior art and conventional workflow technology systems support conditional branching, parallel processing and data security functions to enable many business processes. The prior art separates the design and execution of business applications and business processes which create documents from the record management policies attached to completed documents. Such record management policies move control of the document from the end user (“User”), who created the document, to record management administrators, who set rules and policies on accessing and disposing of documents to meet regulatory and audit requirements. For example, Adobe EPAPER document generation software allows end users to generate a form or document; however the EPAPER platform does not allow a business process manager to also define record management rules for documents once they are created by the end user. IBM E-RECORDS MANAGEMENT document management software assigns record management rules and policies to be applied against documents created by other business applications but no known software applications combine the definition of document creation with the definition of record management policies appropriate for such documents. Furthermore, no existing record management processes enable the application and execution of unique records management rules against a single document that can vary by organization in a collaborative environment.

As one example, employers are presently required to document the eligibility of employees by completing an Employment Eligibility document, such as an I-9 form. Both employees and employers share the responsibility to document on an I-9 record certain identity information and documents ascertaining the employee's right to work. If the employee's Right to Work document identified in the I-9 record has an expiration date, the employee is responsible for renewing his Right to Work documents. The employer is also responsible for assuring the renewal of any Right to Work documents of all employees. In particular, the employer must also comply with records management regulations related to the storage, retention and disposition of the I-9 form and related documents in a file for governmental review. Many employers would further benefit by storing certain images of, and/or references to, electronic images of employment relevant documents or other employment related identity documents and identity eligibility processes as part of an I-9 electronic file or folder within a shared electronic workspace. The employer may further benefit by an automated method that supports maintaining compliance with legal or regulatory rules for confirming the eligibility of employees to work through the completion of the I-9 and the management of work document expiration dates. The prior art fails to provide a processes to define a collaborative workspace that optimally enables a participant of the workspace to create I-9 documents and support fulfillment of rules related to actions for hiring or terminating an employee and associated record management rules for such I-9 documents and files.

The prior art further fails to provide optimally automated business rule and workflow software methods that enable users or participants such as employers, employees and related third parties like a governmental immigration or naturalization service or agency (“INS”), to collaboratively start, complete, validate, store and dispose of the I-9 record and associated images or references to identity management documents and subject files. For example, once certain identity documentation, i.e., an SSN, referred to in the I-9 is confirmed by the agency originally issuing the identification data, the receipt of the authenticated identification of an employee might be stored and shared with the I-9 subject file and other employment records, such as the processes related to wage or tax reporting, e.g. a W-4 process, or to direct deposit of an employees wages or earnings to a financial account maintained by a financial institution, whereby such processes are collectively defined as an electronic new hire subject file and whereby such records and images comprising a subject file can be generated, stored and retrieved for audit or other regulatory purposes.

It is understood that the terms user and participant are defined herein as synonyms and include person, groups, associations, entities agencies, and firms that are authorized or intended to view or use any aspect of a relevant embodiment of the method of the present invention. It is understood the business processes can differentiate allowable processes for Users who generate the I-9 record and Users with retrieval and disposition rights to the completed I-9 record and subject file.

Certain preferred embodiments of the method of the present invention apply automated business processes to the creation, processing, disposition and storage of an I-9 record, and optionally including any related identity documents or other documentation included as part of the I-9 subject file proving or intended to prove compliance with I-9 regulatory and legal policies as electronic images or pointers to external objects and files attached and managed within the I-9 files. Specifically, certain alternate preferred embodiments of the method of the present invention enable the electronic capture of data on the I-9 form, the attachment and storage of images of I-9 identity documents, and the attachment and storage of results of real time validation of identity fields through the execution and capture of automated processes, wherein these automated processes may include requesting and receiving a renewal of identity documents from relevant agencies, such as the United States immigration agency, or an INS of another nation, as part of an I-9 or Employee subject file, and optionally the specification and execution of automated records management processes to all records and images within a subject electronic file folder.

In addition, employees would benefit if notified when a document provided when a proof of identity is subsequently revoked by the authenticating agency that provides the source identity related documents. Employees are often particularly concerned with ensuring that such legally significant information is properly stored or kept and is properly related to a specific subject for audit and regulatory purposes.

Thus automated workflows used in processing Right to Work documents, I-9 employment eligibility forms, and related subject file documents identifying a specific individual are designed to validate the integrity and sanctity of, and enable the further proper use of, personal data and personal identity documents. Examples of documentation workflows that require reliable identity verification include I-9 reporting, W-4 processing, direct deposit of wages to employee owned bank accounts, and a multitude of other reporting processes.

The prior art is largely driven by manual processes to complete, file, store and dispose of I-9 forms and related images of identity documents or by client-server processes which may electronically complete an I-9 but does not have inherent real time validation of identity data as part of a single collaborative workflow or any definition and execution of records management rules and policies applicable to records and subject files created by Users These conventional techniques lack business process management paradigms that may optimally allow the integration of data and identity verification in workflows that enable and insure conformance with regulatory and legal requirements for completion, storage and disposition of I-9 records and related subject matter forms.

Conventional art “trusted centers” like the IWW Certification Center operate via the Internet and offer information technology (IT) based security services for performing trusted transactions via the Internet between two or more business processes and/or participants. These services allow reciprocal authentication of the participating parties e.g. by using certain interchanged certificates. But these prior art systems do not support validation of information provided by the user with any regulatory agency who provided the identity information, such as a state Department of Motor Vehicles or the SSA.

Software may also be available to enter and complete the I-9. However, such client server or web-based processes are not workflow based and are not connected in a collaborative environment to provide real time validation of data entered on the I-9 or to initiate and automatically execute workflow enabling the employee to renew identification documents through collaborative processes linking the employee with the agency responsible for renewing his identity document. The prior art processes do not define and apply record management rules and policies on viewing and disposition of forms stored as part of a subject file. A subject file may be or comprise a collection of records, including pointers to records or images, with the same subject or concerning the same activity.

The United States immigration agency(ies) and the Social Security Administration (“SSA”) provide processes enabling an employee to input a Social Security Number (“SSN”) or an INS personal identification number (“ID”) and receive validation from the INS and/or the SSA that submitted data is accurate. It is undertsood that an ID number may include alphanumeric and other suitable characters known in the art. However, such prior art processes are standalone processes and require employers to input the information entered on the I-9, and then reenter the data into an INS or SSA validation screen, making such validation processes subject to error and requiring the employer to set up a separate manual process for storing validation results with the I-9 paper file or other employment paper files identifying an individual by name or SSN. In addition, the employer is responsible for manually tracking any mismatches of data and may be subject to fines and civil law penalties for misuse of private personal data, or for reporting or endorsing invalid data as valid data.

It is an object of the method of the present invention to provide a method of generating documents by at least two participants within a collaborative electronic workspace.

It is an object of certain preferred embodiments of the method of the present invention to provide an automated business process for processing, storing, and disposing of the I-9 Form and associated images and records stored by subject matter as electronic files and folders, including the use of a collaborative work space operating on the Internet and/or with access via phones, wherein the automated business process facilitates compliance with the completion of the I-9 and related images or references to identity verification and eligibility to work.

### SUMMARY OF THE INVENTION

Towards this and other objects that will become obvious to one skilled in the art and in light of the present disclosure, a method of completing, storing and disposing of employment related documents, to include Employment Eligibility documents, such as the I-9 form, including identity verification and renewal of identity eligibility documents is provided by the present invention. In a first preferred embodiment, automated business processes are implemented in software and via a communications network, such as the Internet. The automated business process software (“ABP) may be created use suitable software languages, such as BASIC or C++, and/or business process software generation tools known in the art, such business process modeling software systems. The automated business process software may include a rules engine and or a grammar engine that support the communications interaction and information processing between or among two or more participants. The metadata descriptors may optionally, alternatively or additionally include the definition of not only rules for Users to generate records but appropriate metadata descriptors required to execute Records management retention and disposition rules and policies which embed an automatically execute defined Records Management processes defined for subject matter files and folders in a specific group of Users or an Organization. Such metadata descriptors can define records, files and subject matter folders and index for retrieving such records, files and folders. The first preferred embodiment further optionally provides a shared collaborative workspace, wherein two or more participants may share information relating to, or comprising, databases, screen formats, emails, instant messaging communications and other suitable data and data structures known in the art. Access to and ownership of data provided within the collaborative workspace may be provided to each participant as either a User or a Records Management User according to a protocol of access levels and clearances, wherein access to read and/or use data associated with or contained within the collaborative workspace may be shaped according to legal authorizations, privacy policies, need-to-know requirements, timing considerations, network priority standards, and/or conditions or acts of independent legal significance.

In the first preferred embodiment, access to automated business management processes for the I-9 and for validation and renewal of related identity documents is made possible via the ABP and available via the Internet to a plurality of participants, to include participants selected from the group that includes an employee, an employer, a human relations department, the INS, the SSA or other governmental financial service, the passport office of the State Department of the United States or other national authority, law enforcement agencies, the United States Department of Homeland Security or other governmental or national security agencies, at least one state drivers' license bureau, at least one vital records office, and a public safety office/law enforcement agency.

The method of the present invention enables a second preferred embodiment of the method of the present invention to optionally implement and execute one or more of the following features via the network and optionally by means of both or either voice or data communications, that may comprise the use of (1) MICROSOFT OUTLOOK contact management software, (2) another suitable contact management software known in the art, (3) a web page, and/or (4) a telephone voice mail box or system, with a person, group, firm or agency:

The ABP software protects the rights of ownership of data of the participants;

The ABP software manages the rights of users to participate in workflow events that are managed by user roles or user organizations;

The ABP software enables the computer network to code data in an electronic record to be available for viewing by third parties in accordance with the Freedom of Information Act;

The ABP enables entries into electronic records for validating identity to reduce actual or perceived risks for insurance purposes;

The ABP enables the computer network or one or more computer systems to operate in a bi-lingual mode selected from the group of communications modes including voice, video screen layout and print;

The ABP allows participants to exchange data in accordance with their data-ownership rights;

The ABP business rules automatically adjust workflow processes to accept defined electronic signatures, which may include the use of a Personal Identification Number, a digital certificate, a Smart Card or other legally acceptable documents, records or data processed for electronic signatures;

Automated processes determine when and to whom activities are routed;

Business rules route data, notifications, escalation, report requests, business service requests and business process execution steps in relation to the urgency of the routed request, demand or information;

Users can click on a notification and automatically launch an event requiring an action from the user;

Users can click on a line in an electronically stored report identifying a record and automatically display an expanded view of the record;

All or selected participants are authorized to change documents (in draft form, in stored form, and/or in final draft form) and have total or limited access to documents, such as the INS Unexpired Temporary Card, a certificate of legally authorized U.S. residence, and responses or revocations to communicated or submitted documents, on an immediate or delayed basis;

Define, modify and manage participant authorities and access rights to information contained within, associated with or available to the collaborative workspace;

Automatically initiate and execute requests by and from the employee to request the renewal of identity documents per regulations or business rules associated with expiration dates of identity documents from agencies issuing identity documents, such as the INS;

Capability to read hidden data contained in a chip or an RFID tag created by an identity document issuer which may be embedded on an identity document and store such data or confirmation results in the correct subject matter or data field of the I-9 record;

Capability to write hidden data contained in a chip or an RFID tag on an I-9 form or an identity document which links a paper form to an electronic record associated with a specific subject matter file;

Defining a database structure for the I-9 electronic file enabling an image of the identity document to be read as a digital image and stored as an attachment with a specific I-9 record.

Both the I-9 and the associated images may be stored as objects in the I-9 file;

The I-9 records management processes may manage both the storage, disposition, deletion, check out and retrieval of the I-9 record and all or some associated subject matter documents or events and optionally incorporate an RFID tag appended to or associated with a physical document for tracking, authenticating, locating and/or monitoring the physical document;

Acceptance and processing of multi lingual forms as either data or voice input and on visual displays, both print and on an electronic display screen including the ability to convert a document stored in one language to another be viewed in another language based upon language preference of the User;

Integrating records management business rules which understand and automatically execute rules and policies applicable to legal and regulatory rules applicable to storage, viewing and disposition of a group of subject matter records, wherein said business rules may include processes for reviewing records before disposition, and enabling a record to be extended or held past a normal retention period to meet audit, confidentiality, organizational or legal requirements;

Maintaining revisions to documents which can be retrieved and displayed as an audit trail when necessary for audit and legal purposes;

Accepting and generating paper versions of stored electronic records when required as part of a check out or check in process and/or optionally, additionally or alternatively tracking and validating the authentication of such subject matter paper files by reading or writing appropriate file/folder information in RFID tags on such documents to help ensure authenticity of data;

Request validation from an issuer of identity documents of document data, including name, number, issue date, expiration date, and other data;

Request renewal or replacement of an identity document from the issuer of the identity documents;

Notification to a participant of actions related to a request by a third party to access the participant's data or identity documents and storing such actions as part of the I-9 file;

Provide automated business processes to the collaborative workspace environment while managing and formatting information in relation to a participant's needs, methods, role(s) and business processes.

Meet all or some legal, regulatory, or organizational records management requirements for the storage, disposition, circulation and retrieval of the I-9 form and related subject matter documents; and

Providing an electronic repository(s) or multiple electronic repositories storing active and inactive records meeting all legal and regulatory requirements for I-9 storage, retrieval and disposition.

In a third preferred embodiment of the present invention, an embodiment of the invented ABP software is used to implement a workfilow whereby steps related to Users completing the I-9, validating identity documents, renewing identity documents, and creating electronic I-9 files are shared and communicated between and among appropriate participants. The third preferred embodiment may be actualized via the Internet and by means of suitable ABP software known in the art to optionally implement one or more of the following steps or features:

storing a workflow for the first document structure within a computer network (“network”), the first document structure describing an Employment Eligibility form layout, such as an I-9 document layout, and the first document layout for generating a visual presentation of the form in accordance with rules established for the user role accessing the form;

providing access to a participant, i.e. a user, via the network to enter identity information associated with an identified person;

providing access to a participant, i.e, a user, via the network to identity the issuer of an individuals' identity documents, the number and expiration date of identification documents by the network from the user and forming therefrom the first set of I-9 information;

storing an image of identity documents with the I-9 record for a specific individual and managing both the attachment and I-9 as a single instance of an I-9 process within the network and as a single subject matter file;

providing business rules and automated business processes for both synchronous and asynchronous communications with the issuer of the identity documents to validate the identity data provided by the individual, wherein the issuer processing systems is communicatively linked with the network either through automated types or methods of message exchanges and/or through automated notifications to review and validate information on a screen;

transmitting the first set of identity document data to the office issuing the identity documents client via the Internet;

generating a first version of the first I-9 form, wherein the information content of the first version is derived from the first set I-9 information and the visual presentation of the first version is at least partially influenced by the first document structure;

providing an I-9 document update module configured to enable a user to generate an updated first set of immigration information by selectively updating the first set of immigration information;

allowing the second user to generate the updated first set of immigration information;

transmitting the updated first set of I-9 information and related identity documents via the network to the agency(ies), organization(s) or entity(ies) who issued the identity documents;

providing visual presentations of information transmitted via the network wherein the visual presentation is presented on a display device of the network, or linked to the network, in a WYSIWYG format

accessing an identity authentication process via the network;

attempting to confirm the identity of the identified person with the identity authentication process by reference to the first set of identity document information;

associating a record of the result of the attempt of the identity authentication service to confirm the identity of the identified person with the first set of identity document information;

notifying the requesting employee of the result of the attempt of the identity authentication service to confirm the identity of the identified person;

linking the network with the Internet and notifying a web service of the result of the attempt of the identity authentication service to confirm the identity of the identified person.

using a web service in the preparation or submittal of an identity document, wherein the web service is selected from the group consisting of a governmental web service, a public safety web service, an insurance database webservice, a vehicular drivers license issuing agency, a financial records monitoring agency, and a vital records repository;

transmitting at least a datum of the first set of identity documents to comply with a governmental immigration or employment law or regulation;

informing the records management manager of a termination of employment of the identified person;

informing a web service of a termination of employment of the identified person, and wherein the web service is selected from the group consisting of a governmental web service, a public safety web service, an insurance database webservice, a vehicular drivers license issuing agency, a financial records monitoring agency, and a vital records repository;

transmitting a set of immigration data to the immigration office client with an electronic signature;

time date stamping an input of information into the first set of immigration information;

deleting the first set of I-9 forms and related identity information in accordance with a preestablished protocol;

associating a first set of I-9 information with a record, the record selected from the group of records consisting of an email, a document draft, an instant messaging communication, a graphic image file, a photographic image file, a video image file, an audio data file, and a text file which can be associated as part of a subject matter file or folder;

accepting information provided via human voice input and optionally over a telephonic or other audio link;

providing bi-lingual or multi-lingual communications between or among an employee, other participant(s) and the collaborative workspace; and

providing payment authorization between parties, whereby payment of a fee required with submission of a document is enabled or automatically tendered.

A fourth preferred embodiment of the present invention enables a participant to manage employment related data and records.

A fifth preferred embodiment of the present invention enables two or more participants separate access to different sections of an electronic document, whereby, for example an employer may provide data to a first section of a right to work document or an employment eligibility document, and an employee may provide data to a second section of the same document.

The method of the present invention may be optionally enabled in the fifth preferred embodiment to route a selected document among participants in order to complete a document and to process the document. Processing the document may include submitting the document to the INS or other business, association, person, or entity. In addition, the fifth preferred embodiment may optionally escalate the notification of and routing of the document to participants in relation to the status of a participant, a law or regulation, or a third party requirement.

Certain alternate preferred embodiments of the method of the present invention more particularly relate to business process management within a shared workspace of an information technology system(s) used to perform identity verification in employment procedures. The automated processes defined for the collaborative creation, storage, indexing, retrieval and disposition of the I-9 can extend and be applicable to automated business processes defined for other documents, such as the W-4 reports, that have legal and regulatory requirements for controlling access rights and providing audit trails and authentication of records once a User(s) follows defined automated business processes for generating and completing a document. In certain still alternate preferred embodiments of the method of the present invention a computer network and a process architecture are provided which understands and manages the statuses of a plurality of participants and the time it takes to enter data for each sections. In certain yet alternate preferred embodiments of the method of the present invention a dashboard presented on a video display of a computer system can indicate time spent on actions and the current status of a workflow established for an electronic record. Certain other alternate preferred embodiments of the method of the present invention enable a plurality of participants to collaboratively generate an electronic, document the method, and format managing security rights to data and understand which participants have rights to enter, edit, view, print or export documents and records. Other aspects of the present invention include an apparatus and a computer-readable medium configured to carry out the foregoing steps.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates a computer network comprising the Internet (optionally accessible by both voice and data) by which a first preferred embodiment of the method of the present invention is implemented.

FIG. 2 illustrates a workflow comprised within a second preferred embodiment of the method of the present invention.

FIG. 3 is a flowchart of a workflow that is comprised within a third preferred embodiment of the method of the present invention and via the network of FIG. 1.

FIG. 4 is an overview of an alternate automated business process software system of a fifth preferred embodiment of the present invention.

FIG. 5 is an overview of a collaborative work environment generated by the automated business process software of FIG. 4 and implemented by means of the computer network of FIG. 2.

FIG. 6 is a relationship diagram of a sixth preferred embodiment of the method of the present invention applied to I-9 and related identity processes.

FIG. 7 is a process diagram of a seventh preferred embodiment of the method of the present invention applied to new records retention processes for I-9 records and associated identity documents.

FIG. 8 is a process diagram of an eighth preferred embodiment of the method of the present invention applied to integrating validated identity data with other identity processes.

FIG. 9 is a process diagram of a ninth preferred embodiment of the method of the present invention applied to a routing of right to work documents for review and approval.

FIG. 10 is a process diagram of a tenth preferred embodiment of the method of the present invention applied to automated fee collection and billing processes.

### DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

First Preferred Embodiment of the Method of the Present Invention

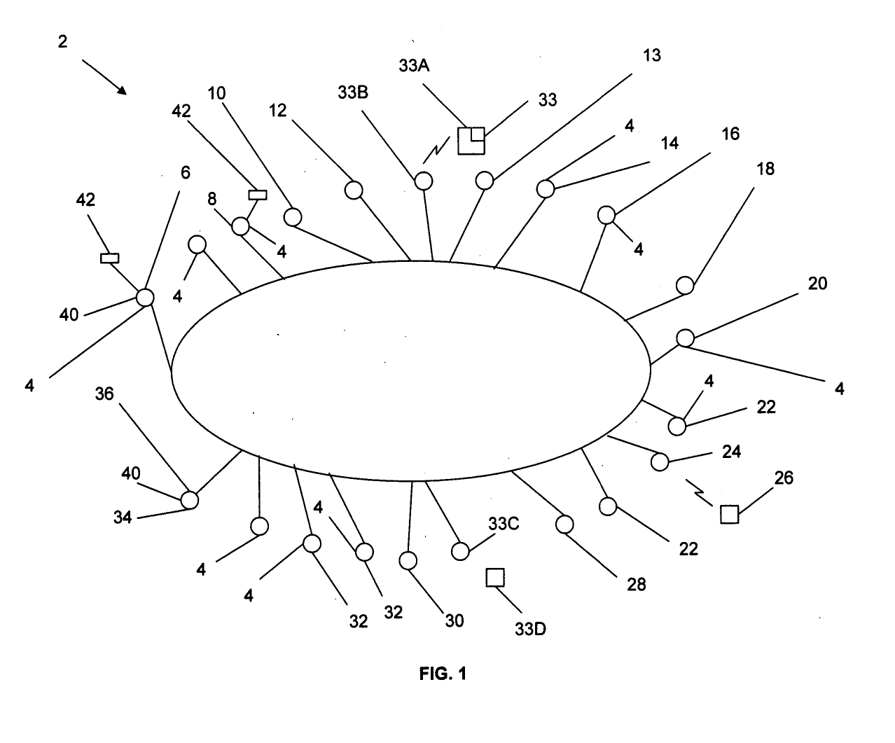

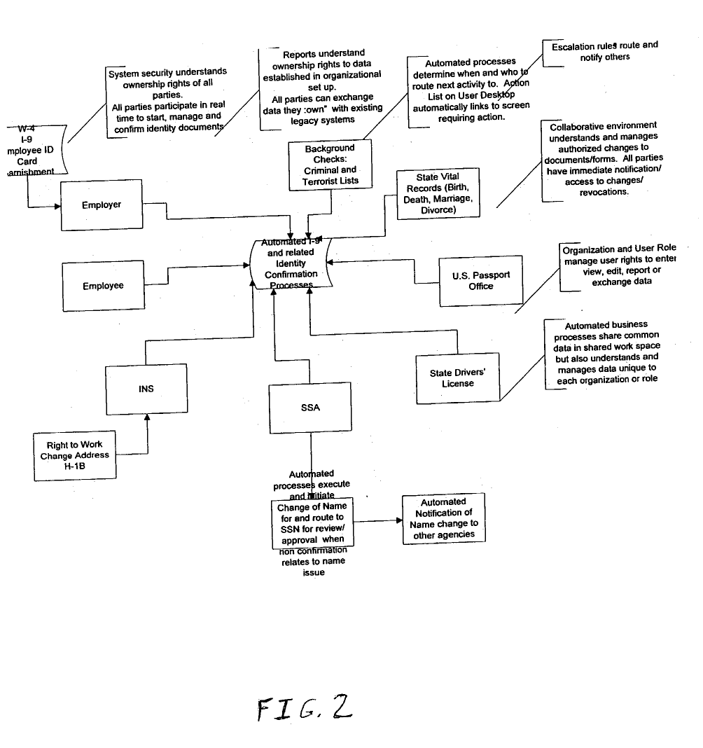

Referring now generally to the Figures and particularly FIG. 1, FIG. 1 illustrates computer network 2 comprising the Internet by which a first preferred embodiment of the method of the present invention is implemented, The computer network 2, or network 2, links a plurality of participant computer systems 4, or systems 4, together for electronic messaging and data access. An employer computer system 6 allows an employer to send information to and receive information from several systems 4 of governmental participants in the network, to include an INS computer system 8, a vital records system 10, an SSA system 12, a vital records office system 13, a state drivers license bureau system 14, a public safety system 16, a Homeland Security Department system 18, and a United States State Department system 20. The network 2 additionally links a plurality of non-governmental systems 4, hard copy scanners 21, databases 22, computer-readable media storage devices 23, wireless link transceivers 24, wireless communications systems 26, telephones 28, voice-to-data translators 29, multi-lingual translation systems 30, and web services systems 32. The wireless communications system 26 and/or the network 2 may optionally comprise an RFID tag 33 appended to or associated with a physical document 33A and an RFID reader 33B, and/or a smart card 33C and smart card reader 33D. A business process management computer system 34, or ABP system 34, is additionally linked with the network 2 and provides, or helps to provide, a collaborative workspace to identified participants, such as the employer, an employee, the INS, and other participants via the network 2 and by means of a suitable business process management software system 36 (“ABP software”) known in the art. The ABP software 36 may be resident on the ABP system (optionally either a hosted system or an enterprise system) 34 and/or partially or wholly distributed within the network 2, and/or among systems 4, data bases 22, and web services systems 24. The ABP software 36 may optionally include a rules engine, a grammar engine, and/or a set or sets of grammar rules, according to the requirements of a collaborative workspace 38 (see FIG. 2). The ABP software 36 may additionally provide a data and transaction security structure, a participant identification system, a participant access level manager, and electronic signature system for encryption and to confirm participant identification in communications, messaging and data transactions. The metadata descriptors available in the ABP software can optionally extend rules for creating data attributes and objects processed as part of a form or document to include records management rules relative to storage, access, retrieval, distribution, indexing and disposal of records Users create. Such descriptors may be defined as a unique rules and policies for different Organizations participating in the creation of the documents.

The term “computer-readable medium” as used herein refers to any medium that participates in providing instructions to the network 2 for execution. Such a medium may take many forms, including but not limited to, non-volatile media, volatile media, and transmission media. Non-volatile media includes, for example, optical or magnetic disks, such as storage device 23. Volatile media includes dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the network 2 for execution. For example, the instructions may initially be carried on a magnetic disk of a remote computer. The remote computer can load the instructions into its dynamic memory and send the instructions over a telephone line using a modem. A modem local to or communicatively linked with the network 2 can receive the data on the telephone line and use an infra-red transmitter to convert the data to an infra-red signal. An infra-red detector can receive the data carried in the infra-red signal and appropriate circuitry can provide the data to the network 2.

The hard copy scanner 21 is used to make a digital image file recording of an image of a hard copy document, such as a hard copy birth certificate, a hard copy passport, or a hard copy driver's license. The resulting digital image file is then transmitted via the network 2 to the database 22, or the computer-readable medium 23, and may be appended to, or associated with, one or more files or electronic documents stored in a database 22, or a computer-readable medium 23. As one example of an application of appending a digital image file to a document, a participant might store a completed I-9 electronic record and then attach a digital image file of a hard copy proof of citizenship document to the completed I-9 electronic record.

The systems 4 may use a suitable web browser known in the art to interact with the ABP software 36 via the Internet. The systems 4 may be personal computers or other workstations that are suitable for and capable of web surfing and additional Internet connectivity.

In the first preferred embodiment, a participant may use a telephone 28 to enter and retrieve data from the collaborative workspace defined by the ABP software 36. The multi-lingual translation systems 30 will accept voice input transmitted from the telephone 28 and then translate and convert the voice input into digital values by means of the voice-to-data translators 29 for access within the collaborative work environment. The voice-to-data translators 29 may optionally be bi-directional and provide information to a participant in an audio form by translating a stored digital value or record into an audio signal. Additionally of alternatively the ABP software 36 may use the network 2 to accept digital tones from the telephone 28 as containing instructions or data as transmitted from the telephone 28 by the participant.

Second Preferred Embodiment of the Method of the Present Invention

Referring now generally to the Figures and particularly FIG. 2, FIG. 2 illustrates a workflow comprised within a second preferred embodiment of the method of the present invention. The collaborative workspace 38 is provided by the ABP software 36 and the network 2. An automated business process defined to complete the I-form and related identity confirmation process may be accessed by a number of participants, to include an employer, an employee, the INS, the SSA, a state drivers license bureau, the passport office of the United States State Department, a vital records office, and a background check and an identity verification agency. The employer and the employee may collaborate on preparing the I-9 form or other employment related form, such as a W-4, by creating a document 40 via a system 4 and storing the results of an identity document matching process 40 in the collaborative workspace 38.

The collaborative workspace 38 optionally enables all or certain of the participants to share access to an electronic representation of the I-9 and to associated data, as well as optionally to digital images of identity documents attached and stored with a unique I-9 record. The ABP software 36 routes notices, alerts and documents among the participants, and escalates priorities of handling and responding to workflows that are accomplished within the collaborative workspace 36. The ABP software 36 protects the rights of ownership of data made available within the collaborative workspace. The ABP software 36 and the network 2 enable participants to exchange data in accordance with their assigned data-ownership rights. Automated processes are routed and escalated according to rules engine and the grammar engine of the ABP software 36. Escalation rules of the ABP software 36 route data, notifications, report requests, business service requests and business process execution steps in relation to the urgency of the routed request, demand or information. All or selected participants are authorized to change documents (in draft form, in stored form, and/or in final draft form) and have total or limited access to all or selected (1) documents, (2) responses and (3) revocations to communicated or submitted documents, on an immediate or delayed basis. The ABP software 36 defines, modifies and manages each participant's authority and access rights to information contained within, associated with, or available to the collaborative workspace. The automated processes optionally define and manage records retention rules for the I-9 form and its related identity documents. Such optional automated processes automatically may manage the storage, retrieval and disposition of I-9 forms per specified regulatory requirements. The method of the present invention further provides automated business processes to the collaborative workspace environment while managing and formatting information in relation to a participant's needs, methods, role(s) and business processes.

Third Preferred Embodiment of the Method of the Present Invention

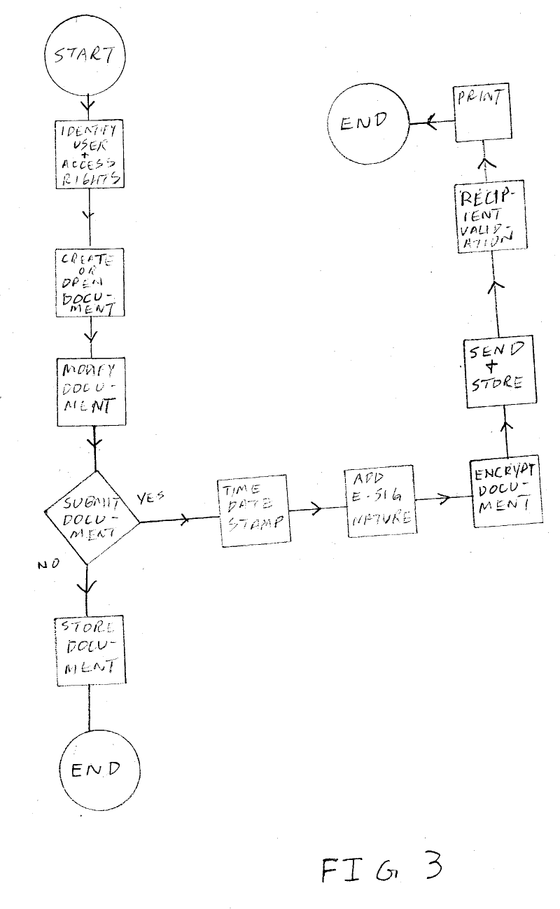

Referring now generally to the Figures and particularly FIG. 3, FIG. 3 is a flowchart of a workflow that is implemented by means of a third preferred embodiment of the method of the present invention and via the network of FIG. 1.

A participant, such as the INS of a national government, may store a first document structure, such as an I-9 format, within the computer network 2, wherein the first document structure describes a first document layout, and the first document layout is used to for generate a visual presentation of immigration data in accordance with a first immigration form standard, such as an I-9 form, and a set of employee-specific immigration information. Other participants, such as the employee or an additional employer, may share access via the network 2 and within the collaborative workspace 38 as provided by the ABP software 36, to create, access or modify a first set of immigration information, where the first set of immigration information is associated with the identified employee and comprising identification, immigration and/or employment data. The collaborative workspace may further enable and authorize an authorized participant immigration data related to the employee via the network 2 to review, verify and/or modify the immigration process related data. The information related to the employee may be stored and shared among the participants of the collaborative workspace 38 as the ABP software 36 allows. One set of immigration information stored within the network may be developed by providing the first document structure to an immigration office client system, via the network 2, and transmitting a first set of immigration data to the immigration office client via the Internet. The collaborative workspace 38 may then enable a participant to generate a first version of the first immigration form, wherein the information content of the first version is derived from the first set of immigration information and the visual presentation of the first version is at least partially influenced by the first document structure

The method of the present invention further provides in the third preferred embodiment an immigration document update module configured to enable a second participant to generate an updated first set of immigration information by selectively updating the first set of immigration information. The collaborative workspace 38 allows the second participant to generate an updated first set of immigration information and transmit the updated first set of immigration information via the network 4 to the immigration office client. The participant may additionally generate an updated version of the first immigration form, wherein the information content of the updated version is derived from the updated first set of immigration information and the visual presentation of the updated version is at least partially influenced by the first document structure.

The ABP software 36 accepts modifications to the first set of immigration information via a client system 4 of the network 2 prior to transmitting the first set of immigration information to the immigration office client, wherein the information content of the first version is derived from the first set of immigration information as modified. A participant may, optionally, additionally or alternatively, delete the first set of immigration information, or other information available via the collaborative workspace, and as allowed and enabled by the ABP software 36, in accordance with a pre-established protocol.

Printed visual presentations of reports, forms, and other information associated with or stored within the collaborative workspace may be output by means of printers 40 (see FIG. 1) and other suitable graphic image generators known in the art comprise or consist of printed media. Additionally alternatively, visual presentations of information transmitted via the network may be shown on a display device of a system 4 of the network 2, to include upon display device of a wireless communications system 26. The visual presentations of the information transmitted via or accessible by the network 2 may optionally be presented on a display device of the network in a WYSIWYG format.

The method of the present invention further optionally provides in the third preferred embodiment a capability of preparing immigration form standard that is related to an employment eligibility document specified by a government agency. In this process, a participant may access the identity authentication service via the network 2 to confirm the identity of the identified person/employee with the identity authentication service by reference to the first set of immigration information, and then associate a record of the result of the attempt of the identity authentication service to confirm the identity of the identified person with the first set of immigration information. The ABP software 36 may then optionally notify the immigration office client of the result of the attempt of the identity authentication service to confirm the identity of the identified person. By linking the network 2 with the Internet and notifying a web service or the INS, or another participant, of the result of the attempt of the identity authentication service to confirm the identity of the identified person, the participants of the collaborative workspace 38 may stay apprised of both legitimate and illegitimate attempts to associate the employee with a specific individual human identity. The web services used in the preparation or submittal of an immigration related document, may be selected from the group consisting of a governmental web service, a public safety web service, an insurance database webservice, a vehicular drivers license issuing agency, a financial records monitoring agency, and a vital records repository. A participant may additionally informing the immigration office client, or other participant(s) of the collaborative workspace 38, of a termination of employment of the identified person or employee. Alternatively or additionally, a participant may notify a web service via the network 2 of a termination of employment of the identified person or employee, wherein the web service may be selected from the group consisting of a governmental web service, a public safety web service, an insurance database webservice, a vehicular drivers license issuing agency, a financial records monitoring agency, and a vital records repository. Participants may transmitting reports and sets of immigration data to the immigration office client with a time-date stamp, an electronic signature, and other suitable encryption and data security or electronic transaction security software tools and techniques known in the art.

The ABP software 36 and the network 2 enable an association of information, such as a first set of immigration information with an electronic record, the record selected from the group of records consisting of an email, a document draft, a graphic image file, a photographic image file, a video image file, an audio data file, and a text file managed and indexed as an instance of a subject matter file or folder. The records may by provided to the collaborative workspace 38 via the systems 4, to include the wireless communications system. Additionally or alternatively, the ABP software 36 and the network 2 enable the collaborative workspace 38 to accept information provided via human voice input and optionally over a telephonic or other audio link, and provide bi-lingual or multi-lingual communications between or among an employee, other participant(s) and the collaborative workspace by means of the multilingual function of the wireless system 26. The ABP software 36 and the network 2 may further optionally enable a participant to provide or receive payment authorization to another participant, whereby payment of a fee required with submission of a document is tendered.

Fourth Preferred Embodiment of the Method of the Present Invention

Currently, INS regulations require employers to obtain proof of citizenship from all new employees. This process is typically done by an employee completing the I-9 form and providing an identification document such as a drivers license as proof of identity. The employer enters identity information from the form such as the type of Document and Document identification number. In some instances, the employer makes a photocopy the identity document and files the photocopy with the I-9 form in a subject matter file. The employer then signs and files the I-9 form in an I-9 file. The I-9 files are then kept as part of an employee's personnel or human resources (“HR”) file. Certain alternate preferred embodiments of the present invention optionally conform to the policy of some organizations to require the I-9 files to be stored in a separate file from other HR forms. This isolation of the I-9 file is done to ensure identification data that may be alleged to form a basis for a discriminatory act is not generally available. Presently in the United States an employer is required to maintain a copy of submitted employee I-9 forms for 3 years, or if the employee is terminated before the end of 3 years, for a period of 1 year after an employee is terminated.

United States immigration agency rules presently require that a proof of citizenship be provided on the same day an employee reports for work. If an employee has lost or misplaced his identity documents, the employer can grant the employee 90 days to replace his lost identity documents.

An ability of the employee to request validation of identity documents from the source issuing the identity documents comprises one optional advantage of the certain preferred embodiments of the present invention, including the optional, additional or alternative ability to store and record such request as part of an I-9 file. This validation of identity documents provides an additional level of assurance that the identity documents provided are not counterfeit. Furthermore, if the employer wants assurance a particular identity document is not revoked or renewed at the end of an expiration date, the certain alternate preferred embodiments of the present invention can additionally or alternatively provide on going monitoring of expiration dates, renewals and revocations of identity documents.

As validation documents may be fraudulent, an employer has no current way of doing real time validation of identity documents with the government agency who is the originating source of the identity data while completing the I-9 form. An I-9 real time validation process of certain preferred embodiments of the present invention will assist employers in doing such validation. In addition, the employer may request such identification of one or more identity documents before offering employment and/or subsequently validate the provided identity data before offering employment.

Referring now generally to the Figures and particularly to FIGS. 1 and 2, certain preferred embodiments of the method of the present invention described herein may provide a collaborative I-9 workflow automating process useful to complete an I-9 submittal, and helpful to monitor the completion of I-9 forms and verification of work documents. This identity verification and data access support may optionally be provided before or after an I-9 is completed and delivered to the United States immigration agency.

Certain preferred embodiments of the method of the present invention provide a workflow and/or event driven I-9 process that may include:

Detecting a “New Hire Event” that creates new instance of an I-9;

Instances of I-9 stored in database with data complete/available in workflow event;

Establish user roles and rights granting access rights to specified I-9 data, or other related or relevant data, while the data is being created or recorded, and after it is stored;

A combination of manual and electronic notification to an issuing source agencies for verification of source document identity and name; and

An extension of I-9 documentation workflow to include an ability to electronically complete and submit requests for Work Authorization;

Automated billing between the employer, e.g., between nFormed or a validating agency to perform validation checks;

Shared database between employer, employee and agency (and optionally other participants) issuing identity documents and validating information is valid:

Immediate notice of confirm or non confirm status;

Inclusion of transaction ID for subsequent actions by verification agency;

Escalation within verification agency if results not returned with specified time; and

Escalation within company if no response within a prescribed time frame to both employer and employee;

Mitigation of security risks yielding a potential for perceived insurance risk reduction and eligibility for lower insurance premiums through appropriate records management processes maintaining confidentiality of identity and validation of identity with identity confirming, verifying or tracking agencies;

Creation and storage of an audit trail of verification request and results.

Optional update client if requested or if subsequent action changes status of subsequent request;

Creation of multiple instances of I-9 in a single I-9 subject matter file if multiple immigration agency regulation Section III's are required for managing work authorization expiration dates for a single individual;

Notification of revocation and storage of such notification in the I-9 file if authenticating agency revokes previous confirmation; and

Creation of an audit trail of time spent by different parties/participants/users completing forms.

Certain preferred embodiments of the method of the present invention provide an employee records generation and/or records management process that may include:

A notification step that a New Hire is received for processing by the system. The notification of a new hire may be done in several, but not necessarily exclusive ways. Such notification may be done by receiving a notification and data about a new hire from the HR system, either manually or electronic. Such notification may be optionally be done by a remote data entry process that reads the employer HR database and extracts new hire employee data;

The new hire data may be either electronically input into the I-9 or the employee logs on and completes Section I of the I-9. The employee may select which identification documents he or she intends to provide as proof of citizenship;

Based upon rules for when verification of documents will occur, the system can either validate documents at this time, or wait and request verification of documents once the employer has signed Section II of the I-9 form, or the system can start the verification process and provide notification of results at a later time;

The employer reviews the documents. New Employer selects which form of ID to provide to employer, e.g., Drivers's License or a Birth Certificate. (NOTE: this list of acceptable identity verification documents is subject to change and will be provided whenever an INS or other government agency dictating policy for valid ID documents prescribes);

If the ID selected is a birth certificate, the I-9 Validation Process will validate the name and DOB with the state registrar or other third party database of birth certificate information;

If the ID selected is a driver's license, the I-9 validation process will validate the name and DOB with a database of drivers' licenses available from the state or a third party who provides access to such records;

The employer may optionally, additionally or alternatively enter the information provided by the employee. The employer may then submit the data to a web-service via the network or the Internet which will route the type of identify selected to the correct data source for validation. The present invention will optionally reply back with a validation of such date. In some instances, the employee might give the employer authorized rights to search such databases for personal information.

Once an initial I-9 from is completed, a copy of the I-9 may be maintained in a central database. The database may receive real time updates from the identity document source systems and may notify the employer if a change in identify is made. If a particular employee is rehired, the system will again validate the identity documents, or if the identity is expired, accept another valid documents to validate identity.

The system may automatically store and retain the I-9 record and associated images, references and identity documents per the records retention rules dictated by the INS Handbook for Employers, or other relevant policy guidelines or regulations. The information may used by employers as a record of the employers' basis for determining eligibility of an employee to work in the United States. The metadata associated with the data objects processed as part of the I-9 and associated documents processing may optionally (a) define records management policies and rules regarding a defied an I-9 record and related identity documents, (b) automatically schedule and dispose of documents, (c) set confidentiality policies, and/or (d) include options to extend data expiration timelines. Such rules and policies include the reading and writing of RFID tags on paper documents and may authenticate or support the authentication of the contents of the documents for legal and regulatory purposes.

Certain preferred embodiments of the method of the present invention may optionally track the amount of time it takes to complete, and provides feedback to the United States immigration agency to provide reporting requirements as prescribed by United States Office of Management and Budget.

The employee may also log on to the network and provide a change of address. The employer may optionally provide a digital signature per accepted electronic signature processes. If a human language translation capability or a translator is required, the system may route the form to be validated by the translator or a translation service. The system will notify the employer 3 years after the date of hire to validate the ID information submitted.

A notice of employment termination will optionally delete records from an I-9 database. Termination notice may additionally or alternatively be available by remote processing of HR or security data files, or by receiving notification from HR department. If a document has been filed but not available, places a 90-day event notice with the document and notifies the employer to validate the identification documents are now available or the employee is no longer eligible for work.

Fifth Preferred Embodiment of the Method of the Present Invention

Referring now to the Figures, and particularly to FIGS. 1, 2 and 4, a fifth preferred embodiment 41 includes an alternate ABP software 42 operating within or comprising a collaborative electronic workspace 44. The alternate ABP software 42, or ABP2 42, operates at least partially within the network 2 and contains a unified database 46 of electronic records 48. An authorization module 50 of the ABP2 42 stores profiles of participants of the ABP2 42 and informs the ABP2 42 of the identity, access rights and authorizations of each participant. A report format module 52 stores the unique formats of a plurality of documents 54, to include an I-9 form 56. As one exemplary operation, a first employee may start an I-9 form for submittal to a first employer. Having creating a profile 58 for the first employee and the ABP2 42 will provide the first employee (via the network 2) with an I-9 format and initiate a first I-9 record 60. The ABP2 42 will permit and enable the employee to populate a first section of the first I-9 record with data. The employee may then cease entering data into the first I-9 record, and submit the first I-9 record to the ABP2 for storage in the unified database 46. The ABP2 42 will then route the first I-9 record to the first employer, and notify the first employer that a completion of a second section of the first I-9 record 60 is pending. The ABP2 42 may optionally escalate the routing of the first I-9 record 60 to the first employer and/or place or indicate a higher priority to the notification or routing of the first I-9 record 60 to the first employer. The first employer may the provide data to the second section of the first I-9 record, as authorized and limited by the authorization module of the ABP2 42. The first employer may complete the second section of the first I-9 record, or cease entering data into the first I-9 record 60, and submit the first I-9 record 60 to the unified database 46. A rules engine 62 of the ABP2 may then determine that the first I-9 record is eligible for submittal to the INS, and thereupon route the first I-9 record to the INS. The rules engine 62 may subsequently inform the employee, the employer, the INS, or another participant or a non-participant third party that an action is required in relation to (1) the first I-9 record 60, (2) an organizational rule, or (3) a governmental regulation or law. An optional grammar engine 64 of the ABP2 42 may inform the ABP2 42 of the personalities of the participants and how the rules engine 62 should be applied to interactions among or between two or more participants. As a first example, the rules engine 62 may direct the ABP2 42 to alert the first employer that the submitted first I-9 record 60 must, by law, be renewed. As a second example, the rules engine 62 may direct the ABP2 42 to delete the first I-9 record 60 after a legally required retention period has expired.

The method of the fifth preferred embodiment of the present invention may be applied to enable participants to collaboratively have access to records 48 stored within the unified database 46, or elsewhere within or linked to the network 2, and optionally to a plurality of document formats.

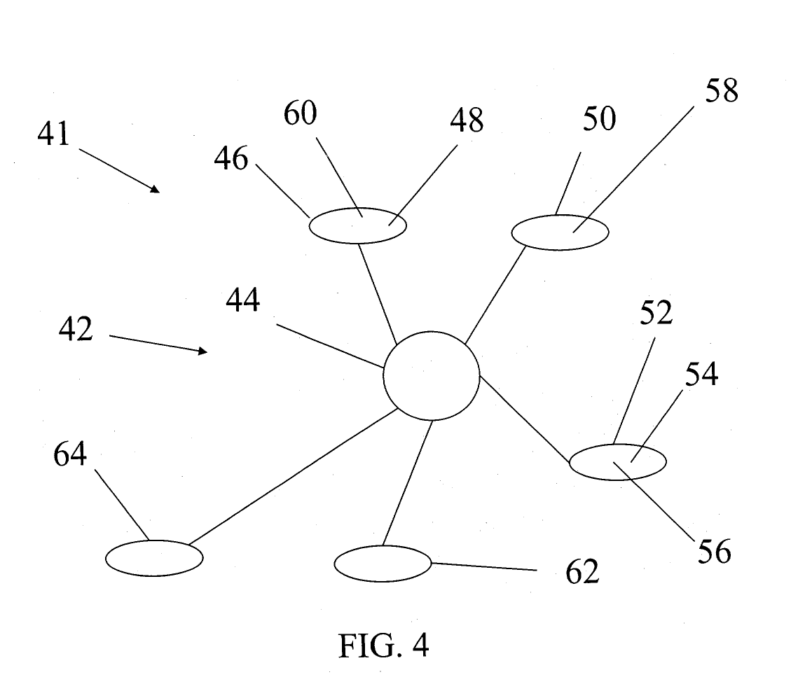

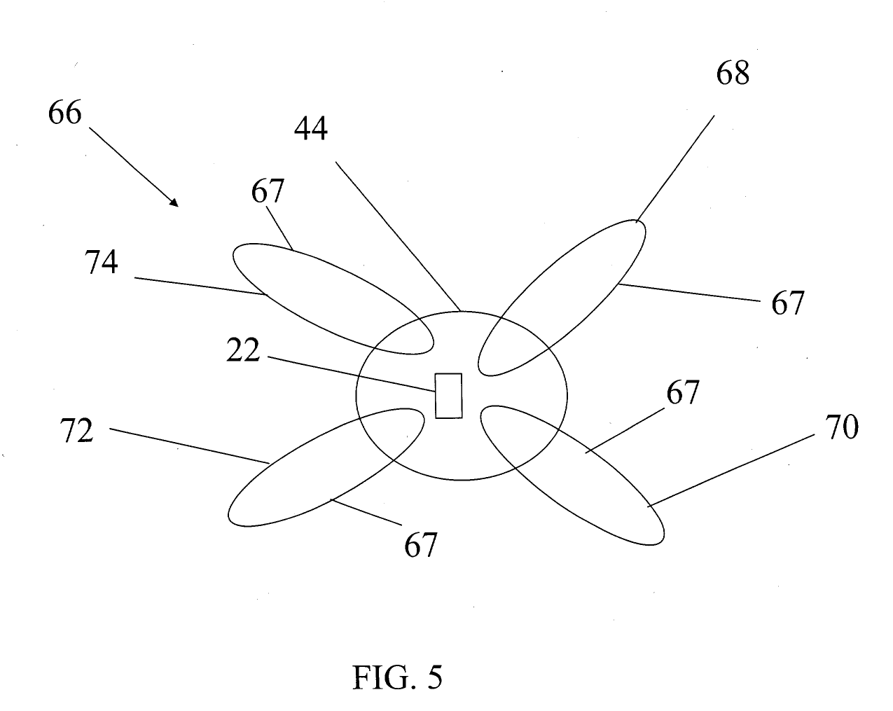

Referring now generally to the Figures, and particularly to FIGS. 1, 2 and 4, FIG. 5 is an overview of a collaborative work environment 66 generated by the automated business process software of FIG. 4 and implemented by means of the computer network of FIG. 2. The database 22 is accessible with a the collaboraitve workspace 44, and available to a variety of business process software systems 67, to include an employment/right-to-work document system 68, an identity verification system 70, a records retention process system 72, and an identity authorization issuer system 74. Access to specific datum and data fields of electronic records stored within the database 22 may be available for viewing and/or editing by each business process software system 67 under the control of the ABP x. so that ownership rules of the data stored in the database 22 are effected. For example, the employment/right-to-work document system 68 may store an I-9 record with an appended digital image file of a birth certificate in the data base 22, and the collaboraitive work environment 66 may allow the identity verification system 70 to access the stored birth certificate digital image file in order to request the identity verification system 70 to either (1) confirm the authenticity of, or (2) deny verification of the authenticity of the birth certificate. In this birth certificate example, the identity verification system is permitted only to view, but not to alter or append to, the stored digital image of the birth certificate, whereas the document system 68 may store and edit the I-9 record and the digital image file.

Sixth Preferred Embodiment of the Method of the Present Invention

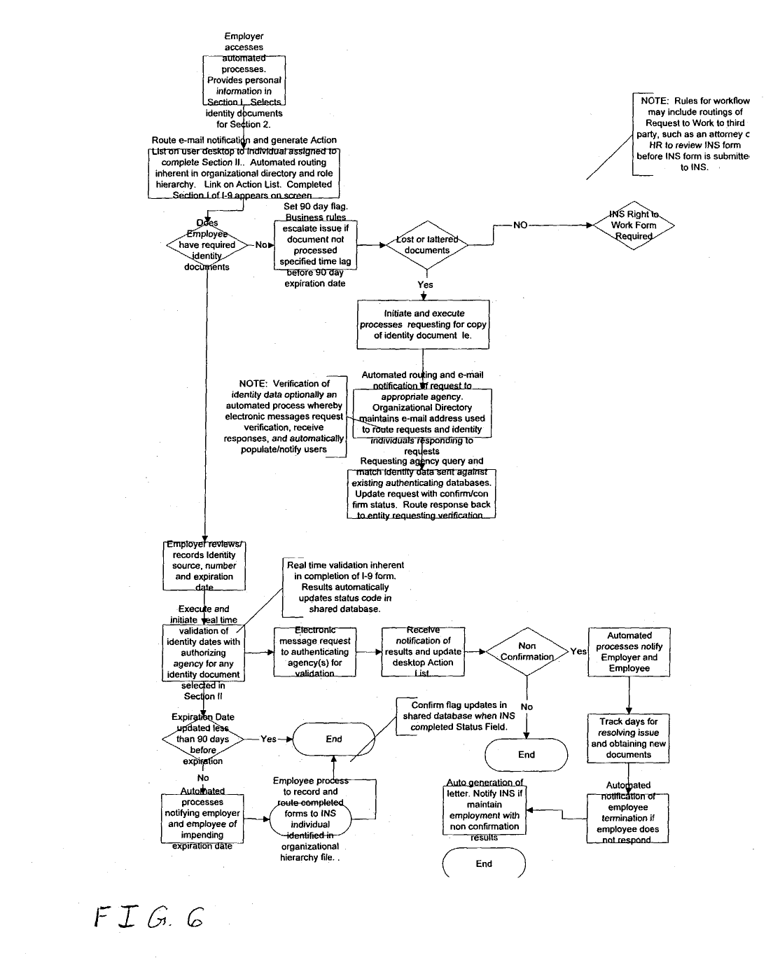

Referring now generally to the Figures, and particularly to FIGS. 1, 2 and 6, FIG. 6 is a relationship diagram of a sixth preferred embodiment of the method of the present invention applied to I-9 and related identity processes.

Seventh Preferred Embodiment of the Method of the Present Invention

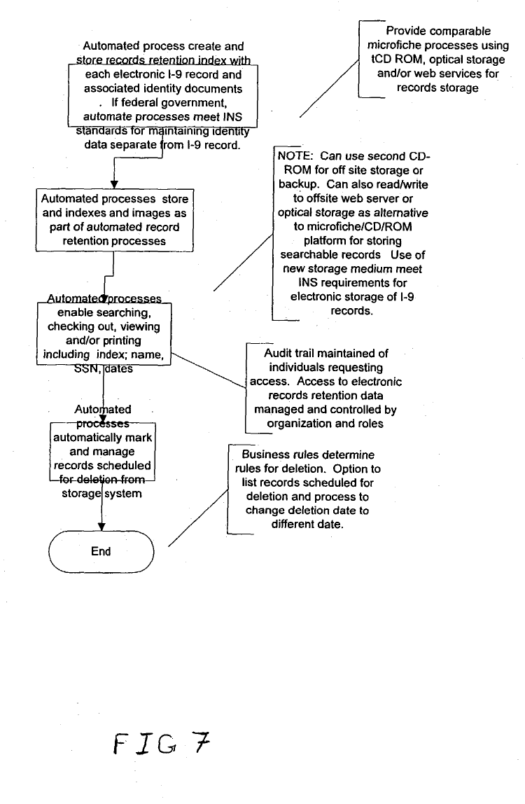

Referring now generally to the Figures, and particularly to FIGS. 1, 2 and 7, FIG. 7 is a process diagram of a seventh preferred embodiment of the method of the present invention applied to new records retention processes for I-9 records and associated identity documents.

Eighth Preferred Embodiment of the Method of the Present Invention

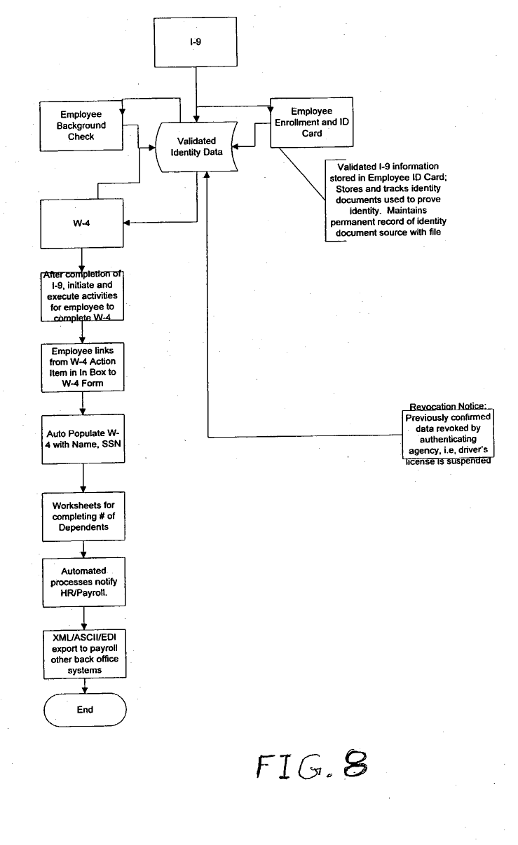

Referring now generally to the Figures, and particularly to FIGS. 1, 2 and 8, FIG. 8 is a process diagram of an eighth preferred embodiment of the method of the present invention applied to integrating validated identity data with other identity processes.

Ninth Preferred Embodiment of the Method of the Present Invention

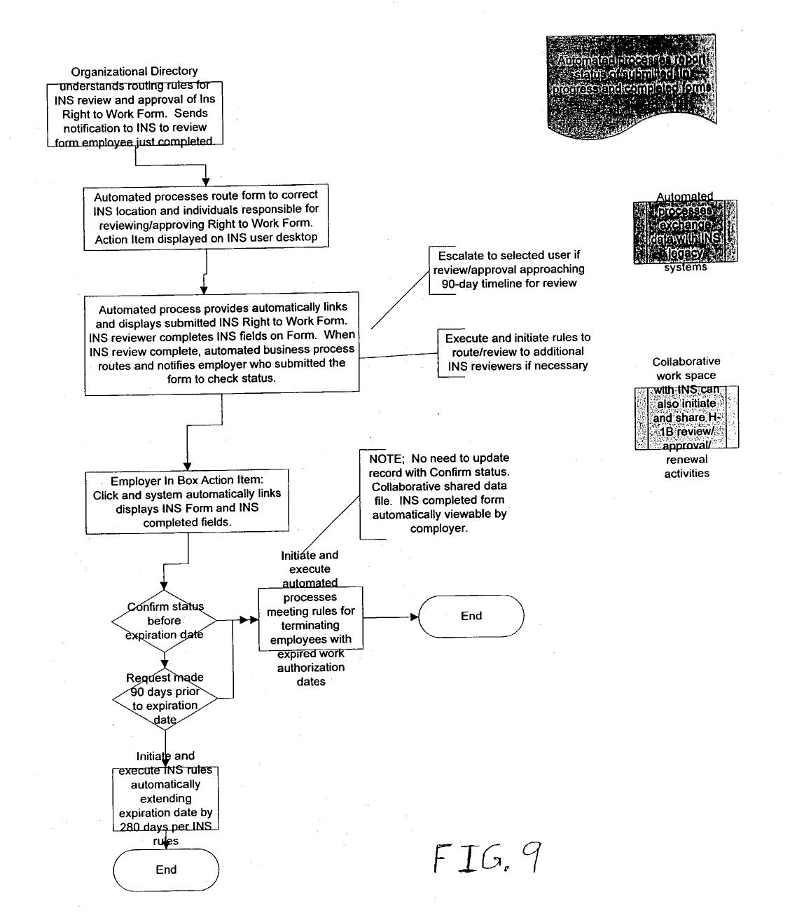

Referring now generally to the Figures, and particularly to FIGS. 1, 2 and 9, FIG. 9 is a process diagram of a ninth preferred embodiment of the method of the present invention applied to a routing of right to work documents for review and approval.

Tenth Preferred Embodiment of the Method of the Present Invention

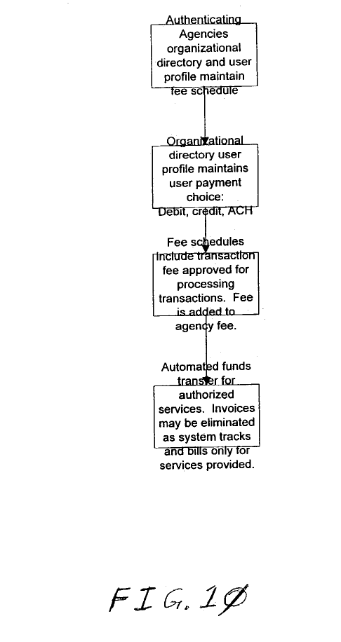

Referring now generally to the Figures, and particularly to FIGS. 1, 2 and 10, FIG. 10 is a process diagram of a tenth preferred embodiment of the method of the present invention applied to automated fee collection and billing processes.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A method for enabling a plurality of participants to collaboratively generate an electronic document in a collaborative electronic workspace and via a computer network, the method comprising:
providing an electronic document format, the format having a first section and a second section, and the format for generating an electronic record;
enabling a first participant to create the electronic record and enter data into the first section;
enabling a second participant to enter data into the second section; and
routing the electronic record to a third participant via the computer network.

2. The method of claim 1, wherein the electronic record format is an Employment Eligibility Record.

3. The method of claim 2, wherein the employment eligibility document is an I-9.

4. The method of claim 3, wherein the third participant is a governmental agency that issues, renews and validates identity documents.

5. The method claim 1, wherein the collaborative electronic workspace further comprises a rules engine, and the rules engine comprises rules related to actions required after the electronic record is submitted to the third participant, and the rules engine informs a participant of the collaborative electronic workspace to at least one required action.

6. The method of claim 2, wherein the electronic record is an employment eligibility document and the third participant is a governmental agency.

7. The method of claim 6, wherein the electronic record is an I-9.

8. The method of claim 1, wherein the electronic document is displayed to a participant in a visual presentation.

9. The method of claim 8, wherein the visual presentation of the first version is presented on a display device of the network.

10. The method of claim 8, wherein the visual presentation of the first version is presented in a printed media.

11. The method of claim 8, wherein the visual presentation of the first version is presented on a display device of a wireless communications system communicatively linked with the network.

12. The method of claim 8, wherein the visual presentation of the first version is presented on a display device of the network in a WYSIWYG format.

13. The method of claim 1 wherein a participant provides data to the electronic record via a telephone, whereby a telephone system establishes a voice mailbox for participants to receive notifications and input data.

14. The method of claim 1 wherein a participant provides data to the electronic record by the scanning or reading and writing of data stored in an RFID tag or a smart card.

15. The method of claim 1, wherein the method further comprises:
sending a request to the computer network from a computer system to access an identity authentication service provided by the issuer of an identity document via the network; and
attempting to confirm the identity of the identified person with the identity authentication service by reference to an identity document information.

16. The method of claim 1 wherein the computer network system generates an individual in-box for at least two participants, comprising:
a listing required actions and due dates of required actions for the participants;
the process engine understanding and linking the participant to the activity requiring action; and
said action list maintaining active until business rules related to actions delete the action from the action list.

17. The method of claim 2 wherein validated identity data on the Employment Eligibility Record can be shared with other electronically stored employment documents selected from the group consisting of a W-4 and a Financial Direct Deposit Form.

18. The method of claim 1, wherein the method further comprises notifying the third participant on a video screen of a computer system of the computer network of the request to validate identity information and the result of the attempt of the identity authentication service to confirm the identity of the identified person.

19. The method of claim 18, wherein the method further comprises linking the network with the Internet and notifying a web service to submit information for validation and to provide of confirm or non confirm results of the attempt of the identity authentication service to confirm the identity of the identified person.

20. The method of claim 1 wherein the method further executes a series of screens and workflow actions dependent on whether a confirm or non confirm status was received whereby a workflow status and adjusts to prior steps and activities taken by the participants is displayed on a video screen of a computer system of the computer network.

21. The method of claim 19, wherein the web service or participant is selected from the group consisting of a governmental web service, a public safety web service, an insurance database webservice, a vehicular drivers license issuing agency, a financial records monitoring agency, and a vital records repository.

22. The method of claim 1 wherein the first participant in the electronic workspace can provide a notice of revocation of an earlier confirmation of an identity to the second participant.

23. The method of claim 1 wherein the participants in the electronic workspace receive notification of an upcoming expiration data on an identification document and the business rules populate necessary documents and workflow enabling a participant to send a request to the issuing agency to review and renew identification documents required to maintain an eligibility to work for a human being.

24. The method of claim 1, wherein the method further comprises informing notification of the termination of employment of a participant to a third participant.

25. The method of claim 1, wherein the method further comprises transmitting the electronic document to the third participant with an electronic signature.

26. The method of claim 1, wherein the method further comprises time date stamping an input of information into the electronic document.

27. The method of claim 1, wherein the method further comprises associating the electronic document with a data file, the data file selected from the group of records consisting of an email, an instant messaging communication, a document draft, a graphic image file, a photographic image file, a video image file, an audio data file, and a text file.

28. The method of claim 1, wherein the method further comprises automated processes to issue payments due for services received from a participant, whereby electronic payment of a fee required with submission of a document is tendered, whereby payment may be made from a debit account, a credit account, and ACH or with a bank check.

29. A method for dynamically managing the completion and storage of I-9 forms and related identity documents with a collaborative information technology system, the collaborative information technology system enabling a plurality of participants to interact via a computer network, the method comprising:
configuring a workflow model of an I-9 form process in a software program stored within the network system, the program comprising a plurality of workflow process steps enabling compliance with all legal and regulatory requirements for completing and storing the I-9;
at least one workflow process step having an associated status, wherein the status can be complete or incomplete;
implementing the workflow by means of the Internet and the software program, whereby the rights and roles of each participant are enabled.

30. The method of claim 29, wherein the method further comprises defining and protecting the rights of ownership of data of at least one participant in the collaborative information technology system and whereby each participants manages and controls ownership of their view of common and proprietary records and data.

31. The method of claim 29, wherein an automated business process provides an electronic records management system for each participant enabling completed records and documents to be electronically checked out and disposition processes allowing authorized individuals to extend or hold a record scheduled for disposition.

32. The method of claim 29, wherein the method further comprises an electronic check out step wherein the an RFID tag is used to authenticate, locate and track documents.

33. The method of claim 29, wherein an automated business process is enabled to code data in an electronic record to be available for viewing by third parties in accordance with the Freedom of Information Act.

34. The method of claim 29, wherein the method further comprises enabling participants to exchange data in accordance with individual data-ownership rights of at least one participant.

35. The method of claim 29, wherein the method further comprises providing and implementing in the software program rules that determine when and to which participant at least one activity is routed.

36. The method of claim 29, wherein the method further comprises providing and implement escalation rules to route an information selected from the group of information consisting of a datum, a notification, a report request, a business service request and a business process execution step.

37. The method of claim 36, wherein the method further comprises routing the information in relation to an urgency status of a data selected from the group consisting of an electronic message, a database value, a request, a demand, an alert, and information.

38. The method of claim 29, wherein the method further comprises defining diverse authorities and access rights by a plurality of participants of the collaborative information technology system to information contained a collaborative workspace.

39. The method of claim 29, wherein the method further comprises providing automated business processes to the collaborative workspace environment while managing and formatting information in relation to a participant's needs, methods, role(s) and business processes.

40. The method claim 29, wherein the process steps enable entities for validating identity to reduce security risks for insurance purposes.

41. The method of claim 29 to operate in a bi-lingual mode selected from the group of communications modes including voice, video screen layout and print.

42. A computer-readable medium carrying one or more sequences of one or more instructions for buffering data, wherein the execution of the one or more sequences of the one or more instructions by one or more processors, causes the one or more processors to perform the steps of:
receiving a request to access data that presently resides in a first buffer, wherein said first buffer is a member of an ordered set of buffers; and
in response to receiving said request, performing the following steps of:
determining a profit value associated with said first buffer, said profit value reflecting a plurality of access characteristics; and
establishing a position for said first buffer in said ordered set based on said profit value.

43. A computer-readable medium carrying one or more sequences of one or more instructions for buffering data, wherein the execution of the one or more sequences of the one or more instructions by one or more processors, causes the one or more processors to perform the steps of:
providing an electronic document format, the format having a first section and a second section, and the format for generating an electronic record;
enabling a first participant to create the electronic record and enter data into the first section; and
enabling a second participant to enter data into the second section; and
routing the electronic record to a third participant via the computer network.
